(19) United States
(12) Patent Application Publication
(10) Pub. No.: US 2002/0056143 A1
(43) Pub. Date: May 9, 2002

(54) Programmable broadband downstream module

(76) Inventors: Winston W. Hodge, Yorba Linda, CA (US); William H. Darnall, Costa Mesa, CA (US)

Correspondence Address: Michael A. Kerr, P.O. Box 2345, Stateline, NV, 89449, US

(21) Appl. No.: 09/823,197

(22) Filed: Mar. 29, 2001

Related U.S. Application Data
(63) Continuation-in-part of application No. 09/162,313, filed on Sep. 28, 1998, now abandoned.
(63) Continuation-in-part of application No. 09/761,205, filed on Jan. 16, 2001.
(63) Continuation-in-part of application No. 09/761,208, filed on Jan. 16, 2001.

(51) Int. Cl. H04N 7/16

(52) U.S. Cl. 725/153

(57) ABSTRACT

The present invention is a programmable broadband downstream module, comprising, a bus interface, a programmable CPU, and a programmable logic. The bus interface is configured to receive a plurality of control data packets and a plurality of transport packets. The plurality of transport packets include a plurality of video transport packets, a plurality of data transport packets, or a plurality of voice transport packets. The programmable CPU is operatively coupled to the bus interface. Additionally, the programmable CPU is configured to combine the plurality of transport packets to generate a programmable CPU output. The programmable logic is operatively coupled to the programmable CPU and is configured to generate a synchronous output for said plurality of transport packets. In operation, a destination address is provided so that transport packets are submitted to a particular downstream module. The downstream module receives transport packets which are intended for the downstream module. The downstream module processes the transport packets according to the programmable CPU and submits packets to the programmable logic which generates a synchronous output.

The present invention is a Continuation-In-Part of patent application Ser. No. 09/162,313 filed on Sep. 28, 1998 and is a Continuation-In-Part of patent application Ser. No. 09/761,205 filed on Jan. 16, 2001 and a Continuation-In-Part of patent application Ser. No. 09/761,208 filed on Jan. 16, 2001.

### BACKGROUND OF THE INVENTION

1. Field of the Invention

The present invention relates to a programmable downstream module for broadband communications. More particularly, the present invention is a software programmable digital headend having a downstream module which communicates video and voice, video and data, and data and voice and any combination thereof in a synchronous manner.

2. The Prior Art

In general, prior art teaches the various downstream modules which communicate either video, data or voice bitstreams with specialized hardware. FIG. 1 shows an illustrative prior art digital headend system 10 which is configured to provide two-way broadband communications. The data communicated and processed by the digital headend 10 includes analog video 12, Internet data 14, and digital video 16. An analog video signal 12 is received by a first upconverter 18. Those skilled in the art shall appreciate that the upconverter provides the appropriate RF communication frequency range for downstream transmission via a cable and/or HFC distribution network to a set top box. Additionally, those skilled in the art shall also appreciate that during upstream communications, a QPSK demodulator (not shown) is used to demodulate the upstream signals for communication with the digital headend.

In the digital headend system 10, the Internet data 14 received by the digital headend 10 is communicated to a central processing unit (CPU) 20 and a point-of-presence (POP) cable modem termination system (CMTS) 22. The CPU 20 performs the function of providing menuing information, conducting accounting and billing, and managing the conditional access control. The CMTS 22 is a data-over-cable service interface specification (DOCSIS) compliant cable headend router which provides an Internet Protocol (IP) standard which allows a plurality of cable modems (not shown) to communicate with the CMTS 22. Downstream data from the CMTS 22 is then communicated to a quadrature amplitude modulation (QAM) modulator 24. The QAM modulator 24 provides a method for modulating digital signals onto an intermediate RF carrier signal involving both amplitude and phase coding which is then communicated to a second upconverter 26. As previously mentioned, the upconverter 26 provides the function of translating QAM modulated data at the appropriate frequency as a plurality of downstream signals. Upstream signals 28 generated by a cable modem (not shown) are then received by a Quadrature Phase-Shift Keying (QPSK) demodulator 30 on the digital headend 10. The QPSK demodulator 10 demodulates digital signals from a RF carrier signal using four phase states to code two digital bits. The digital output from the QPSK demodulator 30 is communicated to the CPU 20 and an out-of-band QPSK modulator 32. The out-of-band (OOB) QPSK modulator 32 provides bi-directional signaling for broadband communications as would be appreciated by those skilled in the art. The OOB QPSK modulator 32 is operatively coupled to an upconverter 34.

The digital video data 16 received by the digital headend 10 is received by the control computer 36 and by a video server 38. Under the guidance of the control computer 36, the video server 38 transmits digital video signals to a QAM modulator 40 which communicates the modulated data to an upconverter 42. The upconverter 42 translates the digital video data at the appropriate downstream frequency for subsequent transmission to a set-top box (not shown). Upstream communications generated by the digital set-top box are communicated to a QPSK demodulator (not shown) which is dedicated to digital video.

The control computer 36 manages the dynamics of digital headend and the Internet data, digital video data and analog data by processing the upstream communications from the set top boxes or cable modems. Further still the control computer 36 determines what movies are loaded onto the video server 38.

It shall be appreciated by those of ordinary skill in the art that an upconverter level adjuster 42 is employed to adjust the level for RF signals communicated by each respective upconverter 18, 34, 42, and 26.

Although not shown, telephony services may also be included in the digital headend shown in FIG. 1. If telephony services were added to the headend described above, they could be provided with a conventional switched telephony system or a voice over IP (VoIP) telephony system. The prior art telephony systems which interface with the digital headend 10 would generally employ downstream QAM modulators with upconverters and upstream QPSK demodulators.

The prior art digital headend system 10 has little or no modularity built into the system. Modularity is defined as the property which provides functional flexibility to a computer system by allowing for the assembling of discrete software units which can be easily joined or arranged with other hardware parts or software units. For example, the prior art digital headend system includes a CMTS 22 which receives Internet data in the form of Ethernet frames using the IP protocol and employs an MPEG-2 transport stream. Additionally, the prior art digital headend 10 includes the digital video 16 which is received as an MPEG-2 transport stream and this MPEG-2 transport stream is also used to communicate the digital video 16 to a set-top box (not shown). Although Internet data and digital video data use the same MPEG-2 transport stream, these two data streams have not been cost effectively integrated. For the co-existence of these two data streams to occur a separate stand alone intermediary hardware and software solution is necessary. The intermediary hardware and software solution does not provide a modular platform.

Additionally, U.S. Pat. No. 6,088,360 ('360) which relates to video multiplexers is a video multiplexer which incorporates a dynamic rate control feature in which MPEG encoded video signals for each channel are stored in a first-in first-out (FIFO) buffer. A packetizer for each channel detects the level in the FIFO buffer and issues a request signal to the video multiplexer that the channel desires to transmit the video signals on the network. The patent discloses the use of tokens to provide giving greater network access to thos channels which require a higher bandwidth. The patent states that by not polling the various channels, but instead sending grant to packetizers with tokens, there is less overhead in the system. This patent is limited to video applications and does not described data and voice communications.

Furthermore, U.S. Pat. No. 5,812,760 relates to the processing of multimedia bitstreams which includes audio and voice. The patent discloses a byte-wise programmable multimedia bitstream parser for an MPEG system. The parser includes an input data organizer, a data management buffer, a register file, a logical unit, and a microprogram controller. The patent provides for the use of status flags and dual register sets to facilitate a byte-wise flow of data which may be more efficiently processed than a serial stream. For a MPEG-2 program stream packet layer the patent describes the identification of a program stream packet layer counter and the packet length counter according to the information provided in the bitstream. However, the patent does not describe the processing of data and voice and the convergence with video.

Further still, U.S. Pat. No. 5,956,338 relates to communication networks which describes a network architecture and data communication protocol for support of both downstream and upstream transport of digital data between a headend facility and multiple downstream network terminals. The headend facility includes a controller which controls the transport of various digital data streams between the headend facility and the respective network terminals. Each network terminal is equipped with a Media Access Controller (NT MAC) for handling various digital data streams transmitted between the respective network terminal and the headend facility. However, a downstream module having a software programmable platform for video and voice, video and data, data and voice, and video, data and voice is not described.

Therefore, it would be beneficial to provide a downstream module which is configured to combine video and data bitstreams, video and voice bitstreams, data and voice bitstreams and video, data and voice bitstreams without a separate stand alone intermediary hardware and software solution is necessary

It would also be beneficial to provide a downstream module which is modular and scalable.

Finally, it would be beneficial provide a downstream module which is configured to receive a plurality of video, data, or voice packets particular to a specific downstream module.

### SUMMARY OF THE INVENTION

The present invention is a programmable broadband downstream module, comprising, a bus interface, a programmable CPU, and a programmable logic. The bus interface is configured to receive a plurality of control data packets and a plurality of transport packets. The plurality of transport packets include a plurality of video transport packets, a plurality of data transport packets, or a plurality of voice transport packets. The programmable CPU is operatively coupled to the bus interface. Additionally, the programmable CPU is configured to combine the plurality of transport packets to generate a programmable CPU output. The programmable logic is operatively coupled to the programmable CPU and is configured to generate a synchronous output for said plurality of transport packets.

A CPU memory support module is operatively coupled to the programmable CPU and the CPU memory support module is configured to provide memory resources for the plurality of control data packets and the plurality of transport packets. A memory module is also operatively coupled to the programmable logic. The memory module is configured to act as a buffer and store the plurality of transport packets and the plurality of control data packets.

Additionally, a downstream modulator is configured to receive and modulate the synchronous output for downstream transmission and generate a downstream modulator output. An upconverter is operatively coupled to the downstream modulator, the upconverter configured to generate a particular RF frequency output for said downstream modulator output.

Generally, the plurality of transport packets processed by the programmable broadband downstream module is a plurality of MPEG-2 transport packets. Additionally, the programmable CPU is configured to perform bit-stuffing, to provide for insertion of control data into said plurality of MPEG-2 transport packets, or configured to perform byte insertions.

In operation, a destination address is provided so that transport packets are submitted to a particular downstream module. The downstream module receives transport packets which are intended for the downstream module. The downstream module processes the transport packets according to the programmable CPU, and submits the transport packets to the programmable logic which generates a synchronous output.

### BRIEF DESCRIPTION OF DRAWING FIGURES

FIG. 1 is a prior art two-way broadband digital headend system.

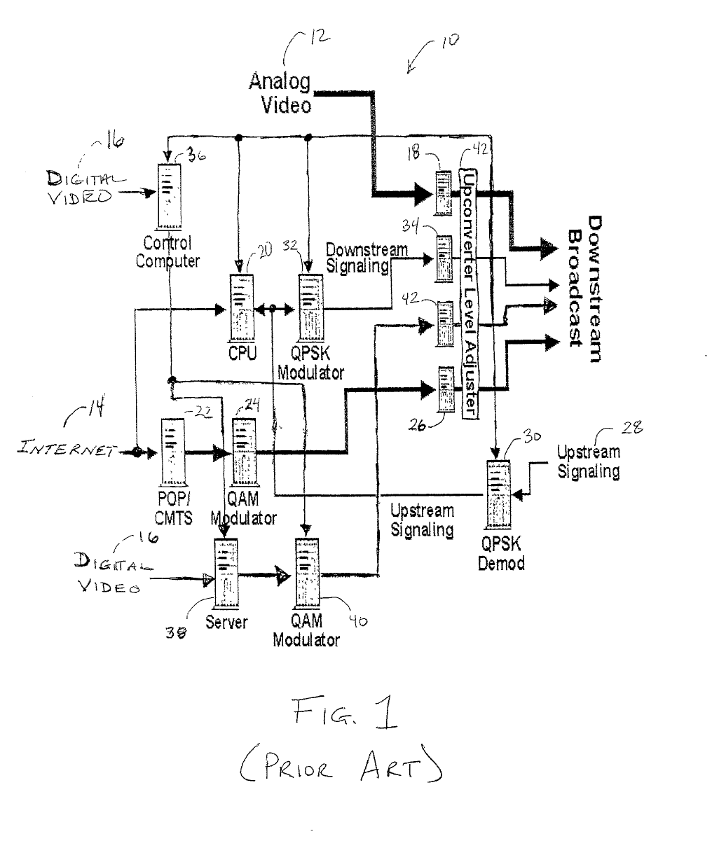

FIG. 2 is a block diagram of a highly integrated computer controlled headend having a plurality of downstream modules.

FIG. 3 is a block diagram of a downstream module.

FIG. 4 is a flow diagram of a downstream module in communication with a smart network interface module.

FIG. 5 is a flow diagram of insertion of packets, bits, and bytes to an existing transport stream.

### DETAILED DESCRIPTION OF THE INVENTION

Persons of ordinary skill in the art will realize that the following description of the present invention is illustrative only and not any way limiting. Other embodiments of the invention will readily suggest themselves to such skilled persons having the benefit of this disclosure.

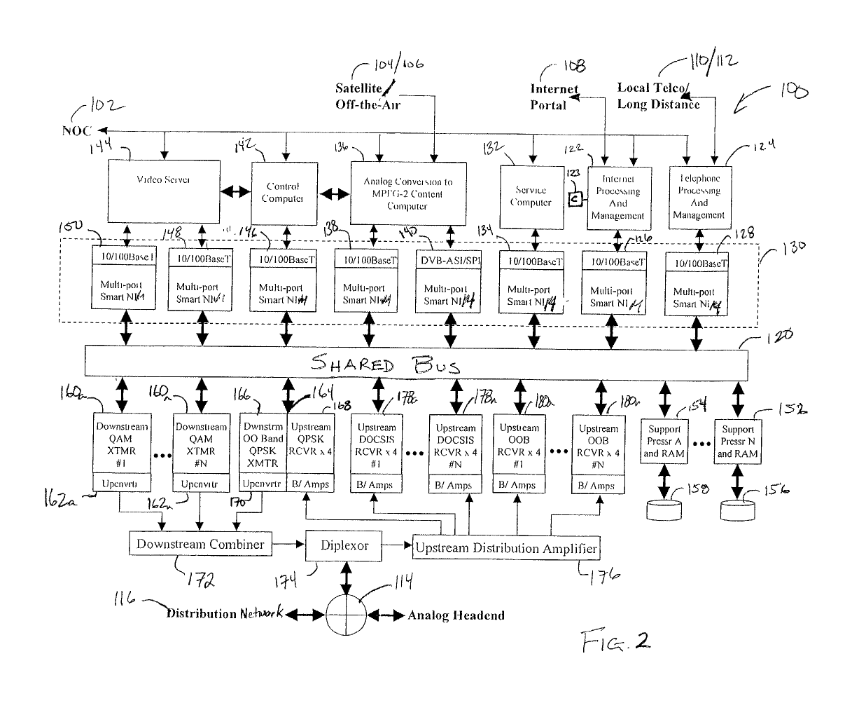

Referring to FIG. 2 there is shown a block diagram of a highly integrated computer controlled headend 100 having a plurality of downstream modules. The highly integrated computer controlled headend 100 is also referred to as a digital headend 100. The programmable downstream module of the present invention is employed in the digital headend.

The digital headend 100 communicates with a Network Operation Center 102, and receives satellite 104 and of-the-air 106 transmissions. Additionally, the digital headend 100 communicates with an Interner portal and with a local telephone company 110 and provides long distance 112 services. It shall be appreciated that the term “video” refers to video signals or video control signals which are communicated by the network operations center 102, satellite 104 and off-the-air 106 transmission. The term “data” refers to the use of the TCP/IP protocol for the communications of Internet, World Wide Web, and any other such communications systems using the TCP/IP protocol. The term “voice” refers to telephony systems and includes IP type telephony systems as well as conventional switched telephony systems.

In the preferred embodiment, the highly integrated computer controlled headend 100 provides the following functions: communicating with a Network Operations Center (NOC) 102; receiving signals from a satellite 104; receiving off-air transmission 106; receiving and transmitting Internet data 108; receiving and transmitting local telephony signals 110 and long distance telephony signals 112, and communicating with a headend system combiner 114.

To perform the functions described above the highly integrated computer controlled headend 100 performs video, data, and voice processing. The video, data, and voice processing performed by the highly integrated computer controlled headend 100 include downstream and upstream signal processing, i.e. bi-directional signal processing. Additionally, the highly integrated computer controlled headend 100 includes a control system which is configured to regulate or “control” the downstream and upstream signal processing.

The highly integrated computer controlled headend 100 comprises a shared bus 120 that permits a high level of integration between video, data and voice signals. Digital video signals provide the representation of video signals in a digital format. Digital data signals are generally communicated in compliance with the data-over cable service interface specification (DOCSIS). DOCSIS is the cable modem standard produced by an industry consortium led by Cable Labs. It shall be appreciated by those skilled in the art having the benefit of this disclosure that the MPEG-2 transport stream is, preferably, employed for communicating said digital video signals and said digital data signals. Voice signals are generally communicated as voice over Internet Protocol (VoIP) or conventional switched telephony. VoIP provides the ability carry normal telephony-style voice over an IP-based Internet with POTS-like voice quality. It shall be appreciated by those skilled in the art having the benefit of this disclosure that VoIP can be represented as either digital data signals. It shall also be appreciated by those skilled in the art that VoIP voice signals are generally communicated using the MPEG-2 transport stream, however, conventional switched telephony systems may also be used with the digital headend 100. Voice signals refers to both VoIP and conventional switched telephony.

Preferably, the shared bus 120 is a parallel bus such as a 32-bit Compact PCI-bus. The 32 bit Compact PCI-bus allows for the use of a combination of off-the-shelf systems which are integrated with downstream modules and upstream modules of the present invention. Since the Compact PCI-bus can only hold a fixed number of modules, a plurality of Compact PCI chassis may be used to satisfy additional system demands, and thereby provide for system scalability. It shall be appreciated by those skilled in the art having the benefit of this disclosure that a 64-bit Compact PCI bus or any other parallel bus may be used. Alternatively, the shared bus 120 may be a high speed serial bus. Regardless of the type of bus employed, it is essential that the bus architecture which provides for the sharing of resources operates in a manner which is open and scalable.

The downstream content which is processed by the highly integrated computer controlled headend 100 is generated by a network operations center (NOC)104, a satellite or off-the-air broadcast 106, an Internet Portal 108, a local telephone company portal 110 and a long distance telephone company portal 112. The NOC 104 provides a variety of different types of information which include content streams for the highly integrated computer controlled headend 100, security procedures such as cryptography, billing information, and post processing work. The satellite or off-the-air broadcast 106 provides the video signals which are communicated using well known RF signalling methods. The portals, i.e. Internet portal 108, local telephone company 110 and long distance telephone company 112, receive and transmit information to the highly integrated computer controlled headend 100.

An Internet processing and management system 122 is in communication with the NOC 104 and the Internet portal 108. A telephone processing and management system 124 is in communication with the NOC 104, the local telephone company portal 110 and long distance phone company portal 112. Well known Internet and telephone processing and management systems 122 and 124, respectively, have been developed by companies such as Cisco Systems and Texas Instruments. The Internet processing and management system 122 provides processing and management for Internet data. The Internet processing and management system may also be operatively coupled to a caching system 123 which stores Internet information that is regularly requested by the digital headend 100. A caching system 123 may include software such as software developed by Inktomi and operate using Sun Microsystem servers. The telephone process and management system 124 provides processing and management of either switched telephony or VoIP signals.

Both of the Internet and telephony processing and management systems 122 and 124, respectively, are operatively coupled to the shared bus 120 via a smart network interface module (NIM) 126 and 128, respectively. Preferably, the smart NIMs 126 and 128 provides a first level of buffering which optimizes the bus transfer rate of the shared bus 120. Alternatively, the smart NIMs 126 and 128 reside on a plurality of downstream modules.

It shall be appreciated by those of ordinary skill in the art that a “bus” is a series of tiny wires that run from one chip to another. The shared bus 120 of the present invention provides an architecture which allows the headend 100 to share headend resources. The shared bus includes address, data and control elements which are communicated in a serial bus or parallel bus. A serial bus has fewer wires and operates generally at a higher speed. A parallel bus has more wires and generally operates at a slower speed. Any combination of a serial bus and parallel bus may also be employed. Preferably, the shared bus employs a 32-bit Compact PCI bus which is a parallel bus.

Although the preferred embodiment of the present invention employs a smart NIM configured to optimize communications across the shared bus, other devices which do not employ a CPU but which provide buffering may also be employed. These devices may include only memory devices which are configured to buffer video, data and voice signals. For purposes of this patent application, the term smart NIM is not restricted to NIM having a CPU. As described in this patent application, the term the smart NIM refers to a controller which is configured to buffer digital information received by that smart NIM. Preferably, the buffered digital information is optimized by the smart NIM for transfer across the shared bus.

The smart NIMs 126 and 128 are coupled to the Internet and telephony processing and management system 122 and 124, respectively, and provide the first level buffering which controls the blocks of data which are communicated across the shared bus 120. Preferably, the smart NIMs 126 and 128 efficiently manage the transmission of bus traffic using block transfer to communicate data across the shared bus 120. By optimizing the data being transferred across the shared bus 102, the smart NIM avoids efficiency losses caused by serial connections between disparate system components. Judicious data management provided by the smart NIM optimizes communications within the highly integrated computer controlled headend 100 by managing the communications between the various components of the highly integrated computer controlled headend 100.

A service computer 132 is in communication with the NOC 104. The service computer 132 performs the function of managing the conditional access, billing and configuration management. Configuration management determines the type of equipment deployed and its maintenance history. The service computer is a robust dedicated general purpose computer. Communications with the shared bus system 132 are accomplished with a Smart NIM 134 which provides appropriate buffering to optimize communications along the Compact PCI bus 120 as described in the body of this specification.

An MPEG content computer 136 receives the satellite 104 and off-the-air signals 106 and converts these analog signals to digital video signals using, preferably, an MPEG digital format. The MPEG content computer 136 also receives ad insertion feeds and converts these feeds to a digital content stream which are inserted into the local (off-the-air) content and the satellite feed content 106. The digital content generated by the MPEG content computer 136 is then fed to a 10/100 BaseT interface which, preferably, provides a MPEG-2 transport stream to a smart NIM 138. Additionally, the digital content generated by the MPEG content computer 136 is also fed to a DVB-ASI/SPI interface operatively coupled to a smart NIM 138 which also uses a MPEG-2 transport stream. As previously described, the smart NIM provides the first level buffering which optimizes the bus transfer rate to the shared bus 120.

The control computer 142 receives control information provided by the NOC 104. The control information includes a program guide, generated at the NOC 104, which is communicated by the highly integrated computer controlled headend 100 to a plurality of set-top boxes 118a through 118n. The control computer 142 also performs the real-time functions of content management and resource allocation for the MPEG content streams. The control computer 142 is a relatively quick and robust computer system compared to the service computer 122. The content management regulated by the control computer 142 comprises the MPEG content from a video server 144 and the MPEG content computer 136. The resource allocation provided by the control computer 142 manages system resources for the highly integrated computer controlled headend 100. The control computer is operatively coupled via a 10/100 BaseT interface to a smart NIM 146 which is operatively coupled to the shared bus 120.

The video server 144 receives content from the NOC 104 or from the MPEG content computer 136. The video server 144 provides local storage for digital video. As previously described, the video server 144 is managed by the control computer 142. The output from the video server 144 is communicated to smart NIMs 148 and 150. The smart NIMs 148 and 150 provide the first level buffering which optimizes the bus transfer rate to the shared bus 120.

A plurality of support processors 152 and 154 having appropriate memory resources are resident as modules which are configured to interface with the shared bus 120. Each support processor 152 and 154 is operatively coupled to disk drives 156 and 158, respectively. Each of the support processors 152 and 154 operate as an individual computer which are operatively coupled to the shared bus 120. The support processors 152 and 154 contain configuration information for the upstream and downstream modules (described below). Additionally the support processors 152 and 154 and their associated disk drives 156 and 158 also contain software programs for the upstream and downstream modules. The support processors 152 and, 154 provide the preferred alternative to managing the addition of software to the highly integrated computer controlled headend 100. By way of example and not of limitation, hundreds of utility programs keep track of time of day, memory addresses, and are responsible for managing the downloading of software to the upstream and downstream modules. When loading software onto the downstream and upstream modules, it is important to avoid loading viruses or other types of software onto the system which will affect the performance of the highly integrated computer controlled headend 100 and the set-top boxes which receive the new software.

More particularly, the process for installing software onto the downstream modules or upstream modules or the set-top boxes includes first receiving software on one of the support processors 152 or 154. The received software is then tested locally on the support processor 152 or 154 to make sure the software is “clean”. A downstream or upstream module is then taken out of service and then loaded with the new software. Diagnostics are performed to make sure the module is operating properly. Once the module has successfully passed the self-test, the module is brought back on-line. When the module is taken off-line and put back on-line, one of the support processors communicates the status of the module to the service computer 132. After the completion of loading the software on the appropriate downstream module or upstream module, the support processor may then move onto the next module and proceed in a similar manner as described above. In general each support processor 152 and 154 communicates the status on each of the downstream and upstream modules to the service computer 132 which in turn communicates this information to the network operations center 104.

The highly integrated computer controlled headend 100 also includes an advanced digital down stream data module 160a through 160n and 166. The advanced digital downstream data modules 160a through 160n provide a highly integrated QAM functionality which improves the management of downstream data, increases reliability for the transmission of the downstream data, and provides for better utilization of available bandwidth. The advanced digital downstream data modules 160a through 160n each comprise a dedicated high-speed embedded processor, an onboard memory, an upconverter, and an automatic level adjuster. The dedicated processor is configured to track the contents of the downstream video, data and voice information and provide refinement in control information. The refinements of control information by the dedicated processor permits data sharing, data muxing, increased security, and improved downstream bandwidth management. It shall be appreciated by those skilled in the art having the benefit of this disclosure that the smart network interface module may be a discrete module operatively coupled to the shared bus or the smart network interface module may be resident on the downstream module, or any combination thereof.

Each advanced digital downstream data module 160a through 160n is operatively coupled to an upconverter 162a through 162n, respectively. The upconverters 162a through 162n have a small footprint and are a highly integrated component of each of the advanced digital downstream data modules 160a through 160n. The small footprint for the upconverter lets the upconverter reside as an extension of the advanced digital downstream data module 160a through 160n, thereby permitting the advanced downstream data module having an upconverter to fit with a single module space shared bus chassis.

The advanced digital downstream data module 160a through 160n is configured to handle video, data and voice signals on the same QAM module. By way of example, and not of limitation, the advanced digital downstream module can be configured to perform CMTS DOCSIS-compliant modem functions and/or digital video transmissions simultaneously. The advanced digital downstream module may also be managed by software which is configured to mix and integrate different types of data, e.g. IP data signals, digital video signals, within a single platform using the MPEG-2 transport stream.

Preferably, the present invention also includes a bi-directional signaling and control module 164 which includes a downstream out-of-band Quadrature Phase Shift Keying (QPSK) transmitter 166 and an upstream QPSK receiver 168. The bi-directional signaling and control module 164 provides the two-way signaling necessary to communicate between the highly integrated computer controlled headend 100 and a plurality of set-top boxes (not shown). The bi-directional signaling and control module 164 includes a powerful embedded CPU which permits local control and management. The downstream out-of-band QPSK transmitter 166 is operatively coupled to an upconverter 170. It shall be appreciated by those of ordinary skill in the art that during out-of-band communications a plurality of control signals are communicated in portions of the broadband spectrum that does not contain program content.

A downstream combiner 172 receives the output from upconverter 162a through 162n and 170 performs the function of combining downstream signals. The downstream combiner 172 is an isolation device which sets gains for downstream transmission, i.e. tilt compensation, and provides system reliability with diagnostic tools. The downstream combiner 172 includes a plurality of passive and active devices which combine the upconverter 162a through 162n and 170 output. Preferably, the downstream combiner 178 monitors the “health” of each downstream encoder 160a thorugh 160n, the downstream out-of-band QPSK transmitter 166, and their respective upconverters 162a through 162n and 170.

A diplexer 174 receives signals from the downstream combiner 170. The diplexer 174 is a high pass/low pass filter which “high” passes downstream information and “low” passes upstream information. The diplexer receives “high” pass signals from the downstream combiner 172 and submits these signals to a headend system combiner 114. The headend system combiner 114 is configured to permit combining the signals generated by an existing analog cable headend (not shown) with the modulated digital headend output generated by highly integrated computer controlled headend 100.

The distribution network 116 receives output from the headend system combiner 114. It shall be appreciated by those of ordinary skill in the art that the distribution network 116 includes a plurality of amplifiers and set-top boxes or modems. The set-top boxes are configured to receive signals from the highly integrated computer controlled headend 100 and the analog headend. Upstream communications generated by the set-top boxes are communicated to headend system 114 which submits the upstream communication to diplexer 174. The diplexer 174 low passes the upstream communications to an upstream distribution amplifier 176.

The upstream distribution amplifier 176 receives upstream signals from the diplexer 174. The upstream distribution amplifier 176 provides impedance matching, inverse tilt compensation, and diagnostic services for the distribution network. The upstream distribution amplifier does not demodulate upstream signals.

A plurality of upstream receiver modules 168, 178a through 178n, and 180 through 180n accept upstream data signals from the upstream distribution amplifier 176. Upstream data signals are communicated in the form of packets which contain the Internet data, telephony data, and system status/control data. Preferably, each upstream receiver module 168, 178a through 178n, and 180 through 180n includes the following components, an upstream tuner, a PCI interface, a CPU and memory support, encryption circuits, and buffer amplification. More particularly, upstream receiver module 168 is operatively coupled with the downstream out-of-band QPSK transmitter 166 and receives upstream communications associated with the data signals generated by the downstream out-of-band QPSK transmitter 166. The upstream receiver modules 178a through 178n receive upstream DOCSIS data and demodulated the upstream signal. The upstream receiver modules 180a through 180n receive out-of-band upstream communications from the distribution network and demodulates the upstream signal. Each upstream receiver module modules 168, 178a through 178n, and 180 through 180n is operatively coupled to the shared bus 120, and submit their demodulated output to control computer 142.

Preferably, a 32 bit Compact PCI-bus is employed. Additionally other parallel buses including a 64-bit bus, 128-bit bus, 256-bit bus and larger shared bus configurations may also be employed. Alternatively a serial bus is also used for the shared bus 120. Additionally, any combination of a parallel and serial bus may also be employed.

By having the highly integrated computer controlled headend 100 with the shared bus system, a variable quality of service (QoS) is achieved. The variable QOS differentiates between different types of data and the way the data is handled. By way of example Internet data may have an acceptable degree of delay between packets. However, voice applications can not have too much delay otherwise the quality of the voice signal is compromised. The highly integrated computer controlled headend 100 has the ability to guarantee the delivery of different types of data in a prescribed manner, and thereby meet variable QoS demands.

The highly integrated computer controlled headend 100 creates a highly flexible, scalable, and modular system design which is configured to run various applications. Additionally, the hardware platform can be configured to reduce the number of analog channels that need to be converted to digital channels thereby optimizing available bandwidth.

The software for the highly integrated computer controlled headend 100 comprises an advanced system software, a digital video broadcast module, and a CMTS headend router software module. The advanced system software wraps around the highly integrated computer controlled headend 100 and controls the advanced digital down stream data module 160a through 160n and the integrated bi-directional signaling and control module 164. In addition, the advanced operating system software creates an applications program interface (API) where external software modules can be inserted and used to run digital applications.

The digital video broadcast module expands the number of broadcast channels it offers and needs only the advanced digital down stream data module to be operational. This module is compatible with the plurality of digital set-top boxes.

The CMTS headend router software module is used to control and manage the advanced digital down stream data module and the integrated bi-directional signaling and control module. The CMTS headend router software provides router functionality to the highly integrated computer controlled headend by controlling encoding, encapsulation, error correction, handshaking, and communications protocols used by DOCSIS.

Alternatively, it shall be appreciated by those skilled in the art having the benefit of this disclosure that each of the individual smart NIMs 126, 128, 134, 138, 140 146, 148 and 150 can be combined in an aggregated smart NIM 130. Furthermore, it shall be appreciated by those skilled in the art having the benefit of this disclosure that any combination of individual smart NIMs and aggregated smart NIMs can be used to accomplish the same objective as described herein.

The digital headend 100 comprises a highly integrated system having a first-level buffering operation which operates in a shared bus environment. The first level buffering provides buffers and generates a destination address associated with a particular downstream module.

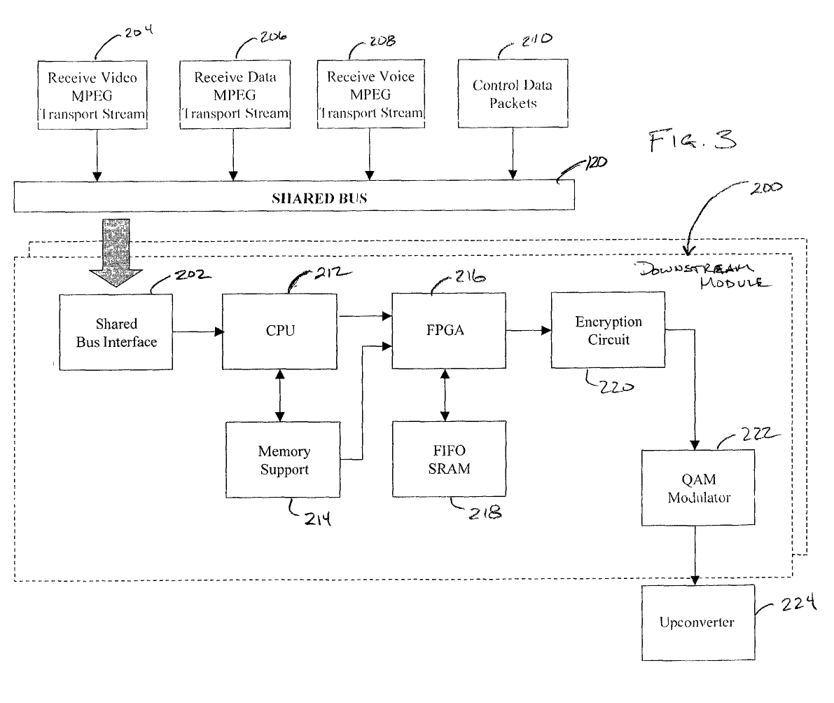

FIG. 3 is a block diagram of a downstream module. The downstream module 200 includes a shared bus interface 202 which interfaces with the shared bus 120. Preferably, the shared bus 202 receives video MPEG transport stream packets 204, data MPEG transport stream packets 206, voice MPEG transport stream packet 208, and control data packets 210.

Referring to FIG. 3 as well as FIG. 2, the video stream packets 204 are generated by the video server 144 and the Analog Conversion Computer 136. The data transport stream packets 206 are communicated by the Internet Processing and Management computer 122. The voice transport stream packets are communicated by the telephone processing and management system 124. The control data packets are generated by the control computer 142 and by any other computer which is configured to generate control packets.

Preferably, the smart network interface module generates a destination address for each stream packet. The destination address identifies the downstream module which will be processing the stream packet. Preferably, the smart network interface module is configured to receive an MPEG-2 transport packet and is configured to determine which downstream module is the target for the MPEG-2 transport packet. The selected downstream module is informed that a packet is ready and the location of the packet.

Referring back to FIG. 3, the downstream module 200 includes a shared bus interface 202, a CPU 212, a memory support module for CPU 214, a programmable logic which is referred to as a field programmable gate array (FPGA) 216, a first-in-first-out (FIFO) SRAM 218, an encryption circuit 220, and a downstream modulator 222. The downstream modulator output is communicated to an upconverter 224.

The CPU 212 is operatively coupled to the shared bus interface 202. The CPU 212 is configured to combine the plurality of transport packets to generate a programmable CPU output which is communicated to a programmable logic 216 which is also referred to as the field programmable gate array. The memory support module 214 which provides memory resources for the CPU 212 is also in communication with the programmable logic 216. The FIFO SRAM 218 is a static RAM which stores the transport packets provided by the programmable logic into the SRAM 218. Once the SRAM is filled, the SRAM transport packets are then communicated via the programmable logic 216 to the encryption circuit 220. The encryption circuit 220 encrypts the transport packets and then communicates the output to the downstream modulator 222. The downstream modulator 222 is preferably a QAM modulator. However, the downstream modulator may also be a QPSK modulator. It shall be appreciated by those skilled in the art that a downstream modulator includes QAM modulation, QPSK modulation and any other such modulating means well known to those in the art. The downstream modulator output is then communicated to an upconverter 224 which selects the appropriate channel for the downstream communications.

Once the downstream module 200 receives the transport packet, the CPU 212 processes each transport stream packet and combines the video, data or voice streams or any combination thereof. The processor combines the different data streams by generating a pointer list and then generating a packet pointer priority list. Preferably, each transport stream packet is a 188 byte MPEG-2 transport stream packet. The SPU 212 also performs the functions of placing the transport packets in a memory support 214. Preferably, the memory support 214 is an SRAM. Additionally, the CPU 212 is configured to compare video program presentation times with those of either data or voice signals or any combination thereof. The CPU then reads the packet pointer list and moves each MPEG-2 transport packet from the CPU 212 or the memory support 214 to the programmable logic 216 in single byte instructions. The single byte instructions are then stored in the FIFO SRAM 218. Once the stack in the FIFO SRAM is filled, the FIFO SRAM is emptied and the output generated is a synchronous output of 188 byte packets.

Preferably, the CPU 212 is a Motorola MPC8240 IC which combines the power of the Power PC CPU with a high performance memory controller and includes a shared bus interface. It is preferable to combine all these functions on to one chip to save circuit board space and simplifies design.

It shall be appreciated by those skilled in the art that the FPGA will control the packet FIFO and generates a serial data stream via the FIFO SRAM 218. The serial data stream is a synchronous data stream which is preferably comrpised of 188 byte MPEG-2 transport packets. It is also preferable that encryption functions will be applied to the serial data stream in the programmable logic 216.

Preferably, the downstream modulator 222 is a Broadcom BCM3033 IC which provides either 64 QAM or 256 QAM modulation. It shall be appreciated by those skilled in the art that the Broadcom chip also inserts null packets where needed as well as tending to the interleaving and forward error correction.

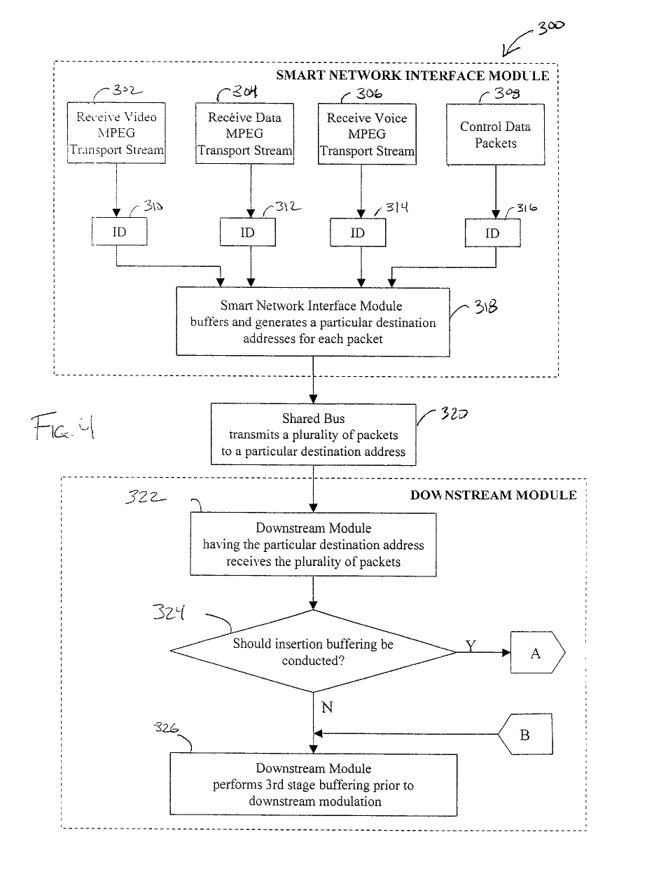

FIG. 4 is a flow diagram of a downstream module in communication with a smart network interface module. The flow diagram 300 shows the data flow from a smart network interface module via a shared bus 120 to a downstream module. Preferably, the smart network interface modules of FIG. 2 receives video MPEG transport stream packets 302, data MPEG transport stream packets 304, voice MPEG transport stream packet 306, and control data packets 308. Each of the video, data, voice and control transport streams has an associated identity which is communicated to the smart network interface module. Preferably the video transport stream 302 is provided with an identity 310, the data transport stream is provided with an identity 312, the voice transport stream 306 is provided with an identity 314, and the control data packets 308 are provided with an identity 316. The smart network interface module then performs a first stage buffering of the various data streams. Additionally, the smart network interface card is configured to receive an acknowledgement regarding availability from a downstream module for one or more identified transport streams. The smart network interface card then proceeds to generate a particular destination address 318 which identifies a particular downstream module which communicated the acknowledgement.

At block 320, a shared bus 120 then transmits a plurality of packets to the particular destination address which is associated with the selected downstream module.

At block 322, the selected downstream module having the particular destination address receives the plurality of transport packets. Referring to FIG. 3 as well as FIG. 4, the transport packets are received by the CPU 212 via the shared bus interface 202. The method then proceeds to decision diamond 324.

At decision diamond 324, the CPU 212 determines whether insertion buffering should be conducted. Insertion buffering includes the addition of control data packets to an existing transport stream, or the inclusion of bit stuffing, or the application of byte insertions. If the CPU 212 determines that insertion buffering is NOT required, then a multiplex of transport packets generated by CPU 212 are communicated to blcok 326. If the CPU 212 determines that insertion buffering is required, then a multiplex of transport packets are communicated to decision diamond 332.

At block 326, the CPU 212 communicates the multiplex of transport packets to the programmable logic 216 and the FIFO SRAM 218. Preferably, the programmable logic 216 output is a synchronous MPEG-2 output of transport packets as described above. The programmable logic and the FIFO SRAM perform a third buffering stage prior to downstream modulation which combines the output generated by the CPU 212 and the memory support module 214. The third buffering stage generates a synchronous output of 188 byte transport packets for downstream transmission.

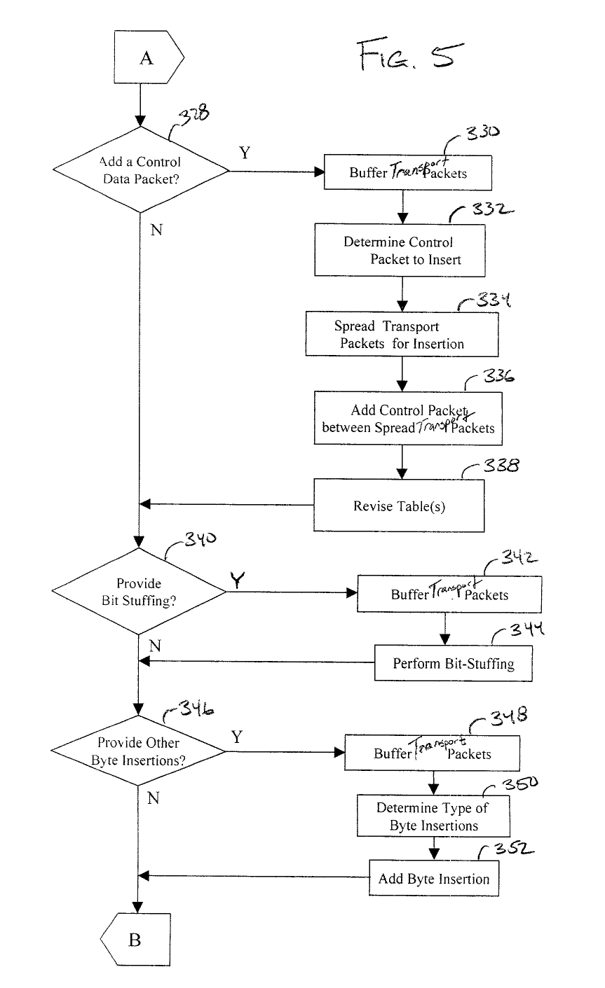

FIG. 5 is a flow diagram of the insertion of packets, bits, and bytes to an existing transport stream by the CPU 212. The insertion of packets is initiated by having made a positive determination that the insertion buffering should conducted as provided by decision diamond 324 of FIG. 4. The method then proceeds to proceeds to decision diamond 328 in which it is determined whether a control data packet should be inserted into the transport stream. If a determination is made that a control data packet should be inserted into the transport stream, the method proceeds to block 330.

At block 330, the memory support module 214 buffers the transport packets. The transport packets may include video transport packets, data transport packets, voice transport packets, or any combination thereof. After the transport packets have been buffered the method proceeds to block 332.

At block 332, the CPU 212 determines which one or more control packets are to be inserted and where one or more control packets are to be inserted into the transport packet stream. The determination may be based on timing intervals, or identification, or on a priority basis, or may be flagged, or any such other combination or determining means well known to those skilled in the art. The method then proceeds to block 334.

At block 334, the CPU 212 spreads the transport packet stream apart. The transport packets are spread apart sufficiently to provide for the insertion of control packets. The method then proceeds to block 336. At block 336, the CPU 212 adds or inserts the one or more control packets between the spread transport packets. The method then proceeds to block 338 in which tables are revised to reflect the insertion of control packets to the transport stream. The method then proceeds to decision diamond 340.

If at decision diamond 328 a determination is made that the addition of a control packet is NOT required, then the method proceeds to decision diamond 340.

At decision diamond 340 it is determined whether to perform bit stuffing. It shall be appreciated by those skilled in the art that bit stuffing is a well-known technique of adding null packets to the data payload portion of a transport packet. Bit stuffing is used to ensure that evenly sized packets are generated. If a determination is made at decision diamond that bit stuffing is required, then the method proceeds to block 342.

At block 342, the CPU 212 buffers transport packets. The transport packets may include control packets. The method then proceed to block 344 in which bit-stuffing is performed. Once the bit-stuffing is performed the method proceeds to decision diamond 346.

If at decision diamond 340 a determination is made that bit stuffing is NOT required, then the method proceeds to decision diamond 346.

At decision diamond 346 a determination is made as to whether other byte insertions need to be inserted into the transport packets. If it is determined that byte insertions are required to be inserted into the transport packets then the method proceed to block 348. At block 348, the transport packets are buffered and proceed to block 350. At block 350 a determination is made of the type of byte insertion to include in the transport packet. The byte insertion may be video, data, voice or control byte insertion or any combination thereof. The method the proceed to block 352 in which the byte insertion is accomplished. Once the byte insertion has been completed the method proceeds to block 326 as described above.

If a determination is made at decision diamond 346, that no byte insertions are necessary, then the method proceeds to block 326 as described above.

While embodiments and applications of this invention have been shown and described, would be apparent to those skilled in the art that many more modifications than mentioned above are possible without departing form the inventive concepts herein. The invention, therefore, is not to be restricted except in the spirit of the appended claims.

1. A programmable broadband downstream module, comprising:
a bus interface configured to receive a plurality of control data packets and a plurality of transport packets, said plurality of transport packets including:
a plurality of video transport packets communicated asynchronously, a plurality of data transport packets communicated asynchronously, and a plurality of voice transport packets communicated asynchronously;
a programmable CPU operatively coupled to said bus interface, said programmable CPU configured to combine said plurality of transport packets to generate a programmable CPU output; and
a programmable logic operatively coupled to said programmable CPU, said programmable logic configured to generate a synchronous output for said plurality of transport packets.

2. The programmable broadband downstream module of claim 1, further comprising a downstream modulator configured to receive and modulate said synchronous output for downstream transmission, said downstream modulator configured to generate a downstream modulator output.

3. The programmable broadband downstream module of claim 2, further comprising an upconverter operatively coupled to said downstream modulator, said upconverter configured to generate a particular RF frequency output for said downstream modulator output.

4. The programmable broadband downstream module of claim 1, further comprising, a CPU memory support module operatively coupled to said programmable CPU, said CPU memory support module configured to provide memory resources for said plurality of control data packets and said plurality of transport packets.

5. The programmable broadband downstream module of claim 4, further comprising a memory module operatively coupled to said programmable logic, said memory module configured to act as a buffer and store said plurality of transport packets and said plurality of control data packets.

6. The programmable broadband downstream module of claim 1 further comprising an encryption circuit operatively coupled between said programmable logic and said downstream modulator, said encryption circuit configured to encrypt said synchronous output.

7. The programmable broadband downstream module of claim 1 wherein said plurality of transport packets are a plurality of MPEG-2 transport packets.

8. The programmable broadband downstream module of claim 7 wherein said programmable CPU is configured to perform bit-stuffing.

9. The programmable broadband downstream module of claim 8 wherein said programmable CPU is configured to provide for insertion of control data into said plurality of MPEG-2 transport packets.

10. The programmable broadband downstream module of claim 9 wherein said programmable CPU is configured to perform byte insertions.

11. A programmable broadband downstream module, comprising:
a bus interface configured to receive a plurality of control data packets and a plurality of transport packets, said plurality of transport packets including:
a plurality of video transport packets communicated asynchronously, and a plurality of data transport packets communicated asynchronously;
a programmable CPU operatively coupled to said bus interface, said programmable CPU configured to combine said plurality of transport packets to generate a programmable CPU output; and
a programmable logic operatively coupled to said programmable CPU, said programmable logic configured to generate a synchronous output for said plurality of transport packets.

12. The programmable broadband downstream module of claim 11, further comprising a downstream modulator configured to receive and modulate said synchronous output for downstream transmission, said downstream modulator configured to generate a downstream modulator output.

13. The programmable broadband downstream module of claim 12, further comprising an upconverter operatively coupled to said downstream modulator, said upconverter configured to generate a particular RF frequency output for said downstream modulator output.

14. The programmable broadband downstream module of claim 11, further comprising, a CPU memory support module operatively coupled to said programmable CPU, said CPU memory support module configured to provide memory resources for said plurality of control data packets and said plurality of transport packets.

15. The programmable broadband downstream module of claim 14, further comprising a memory module operatively coupled to said programmable logic, said memory module configured to act as a buffer and store said plurality of transport packets and said plurality of control data packets.

16. The programmable broadband downstream module of claim 111 further comprising an encryption circuit operatively coupled between said programmable logic and said downstream modulator, said encryption circuit configured to encrypt said synchronous output.

17. The programmable broadband downstream module of claim 11 wherein said plurality of transport packets are a plurality of MPEG-2 transport packets.

18. The programmable broadband downstream module of claim 17 wherein said programmable CPU is configured to perform bit-stuffing.

19. The programmable broadband downstream module of claim 18 wherein said programmable CPU is configured to provide for insertion of control data into said plurality of MPEG-2 transport packets.

20. The programmable broadband downstream module of claim 19 wherein said programmable CPU is configured to perform byte insertions.

21. A programmable broadband downstream module, comprising:
a bus interface configured to receive a plurality of control data packets and a plurality of transport packets, said plurality of transport packets including:
a plurality of video transport packets communicated asynchronously, and a plurality of voice transport packets communicated asynchronously;
a programmable CPU operatively coupled to said bus interface, said programmable CPU configured to combine said plurality of transport packets to generate a programmable CPU output; and
a programmable logic operatively coupled to said programmable CPU, said programmable logic configured to generate a synchronous output for said plurality of transport packets.

22. The programmable broadband downstream module of claim 21, further comprising a downstream modulator configured to receive and modulate said synchronous output for downstream transmission, said downstream modulator configured to generate a downstream modulator output.

23. The programmable broadband downstream module of claim 22, further comprising an upconverter operatively coupled to said downstream modulator, said upconverter configured to generate a particular RF frequency output for said downstream modulator output.

24. The programmable broadband downstream module of claim 21, further comprising, a CPU memory support module operatively coupled to said programmable CPU, said CPU memory support module configured to provide memory resources for said plurality of control data packets and said plurality of transport packets.

25. The programmable broadband downstream module of claim 24, further comprising a memory module operatively coupled to said programmable logic, said memory module configured to act as a buffer and store said plurality of transport packets and said plurality of control data packets.

26. The programmable broadband downstream module of claim 21 further comprising an encryption circuit operatively coupled between said programmable logic and said downstream modulator, said encryption circuit configured to encrypt said synchronous output.

27. The programmable broadband downstream module of claim 21 wherein said plurality of transport packets are a plurality of MPEG-2 transport packets.

28. The programmable broadband downstream module of claim 27 wherein said programmable CPU is configured to perform bit-stuffing.

29. The programmable broadband downstream module of claim 28 wherein said programmable CPU is configured to provide for insertion of control data into said plurality of MPEG-2 transport packets.

30. The programmable broadband downstream module of claim 29 wherein said programmable CPU is configured to perform byte insertions.

31. A programmable broadband downstream module, comprising:
a bus interface configured to receive a plurality of control data packets and a plurality of transport packets, said plurality of transport packets including:
a plurality of data transport packets communicated asynchronously, and a plurality of voice transport packets communicated asynchronously;
a programmable CPU operatively coupled to said bus interface, said programmable CPU configured to combine said plurality of transport packets to generate a programmable CPU output; and
a programmable logic operatively coupled to said programmable CPU, said programmable logic configured to generate a synchronous output for said plurality of transport packets.

32. The programmable broadband downstream module of claim 31, further comprising a downstream modulator configured to receive and modulate said synchronous output for downstream transmission, said downstream modulator configured to generate a downstream modulator output.

33. The programmable broadband downstream module of claim 32, further comprising an upconverter operatively coupled to said downstream modulator, said upconverter configured to generate a particular RF frequency output for said downstream modulator output.

34. The programmable broadband downstream module of claim 31, further comprising, a CPU memory support module operatively coupled to said programmable CPU, said CPU memory support module configured to provide memory resources for said plurality of control data packets and said plurality of transport packets.

35. The programmable broadband downstream module of claim 34, further comprising a memory module operatively coupled to said programmable logic, said memory module configured to act as a buffer and store said plurality of transport packets and said plurality of control data packets.

36. The programmable broadband downstream module of claim 31 further comprising an encryption circuit operatively coupled between said programmable logic and said downstream modulator, said encryption circuit configured to encrypt said synchronous output.

37. The programmable broadband downstream module of claim 31 wherein said plurality of transport packets are a plurality of MPEG-2 transport packets.

38. The programmable broadband downstream module of claim 37 wherein said programmable CPU is configured to perform bit-stuffing.

39. The programmable broadband downstream module of claim 38 wherein said programmable CPU is configured to provide for insertion of control data into said plurality of MPEG-2 transport packets.

40. The programmable broadband downstream module of claim 39 wherein said programmable CPU is configured to perform byte insertions.
